(19) United States
(12) Patent Application Publication
(10) Pub. No.: US 2005/0247844 A1
(43) Pub. Date: Nov. 10, 2005

(54) Baluster hangar

(76) Inventor: Donald Tilton, Merrimack, NH (US)

Correspondence Address: JOSEPH E. FUNK, 82 CHASE RD, LONDONDERRY, NH, 03053, US

(21) Appl. No.: 10/840,012

(22) Filed: May 6, 2004

(51) Int. Cl. E04H 17/14; B42F 13/00

(52) U.S. Cl. 248/340

(57) ABSTRACT

A baluster holder is disclosed that is quickly and easily attached to the sides of balusters on a deck, porch, balcony or stairs without the need for tools. The baluster hangar may attached to the outer side of balusters without having to lean over the railing and balusters, thus making the installation safe. The parts of the baluster hangar are rotated into an installation position and passed between two adjacent balusters before being returned to a final position. Parts of the baluster hangar are then stressed and deformed by pulling on the hook of the hangar and a hangar piece is moved to a position that prevents the stress from being released to thereby lock the baluster hangar tightly against the sides of the balusters.

### CROSS REFERENCE TO RELATED APPLICATION

This utility patent application claims rights under 35 U.S.C. 119(e) from U.S. provisional patent application No. 60/460,369 entitled “Baluster Hangar”, and filed May 6, 2003.

### FIELD OF THE INVENTION

The invention relates to hangars that can mount to the side of balusters on porches, balconies and stairs, and various things such as plants and other decorative items may then be hung from the hangars. The hangar may also be mounted on any two vertical spaced members such as found in many fences.

### BACKGROUND OF THE INVENTION

In recent years there has been renewed interest in the use of plants and flowers for their color and decorative qualities. For example, U.S. Pat. Nos. 4,559,738 and 4,698,936 teach planters and means for attaching the planters to the top or sides of wall partitions such as are frequently encountered in open plan offices.

Another excellent location for planters and flower pots is on the top or sides of various types of railings, both indoors and outdoors. In recent years there has been an increased use of railings and their balusters, as for example on the balconies of high rise condominiums, on the decks of houses, on the decks of above-ground pools, and so on. To date, however, little has been done to provide simple, safe and secure means for affixing a planter or other item on top of or alongside the top rail of a railing structure. Even less has been done to provide simple, safe and secure means for affixing a planter to the sides of balusters supporting a railing.

Thus, there is a need in the art for apparatus that can be used to hang plants, flowers, decorative items and other things to the sides of balusters supporting a railing on a deck, porch, balcony or stairs. There is also a need for such apparatus to be extremely simple and quite easy and safe to install.

### SUMMARY OF THE INVENTION

The forgoing needs of the prior art are satisfied by the present invention. A baluster hangar is provided that may be easily attached to the sides of balusters on a deck, porch, balcony or stairs without the need for tools. The baluster hangar may be attached to balusters on balconies, porches and decks without having to lean over a railing to reach the outside of the balusters which is dangerous, and is extremely dangerous if the balusters and railing are on a balcony of an apartment of a high rise building.

The baluster hangar in accordance with the present invention is preferably fabricated of iron, but may be fabricated of other materials. There are no nuts and bolts and no tools are needed to attach the baluster hangar of the present invention to the sides of balusters.

The novel baluster hangar comprises pieces that are in a rotational relationship with each other and are attached to the outer of balusters, on their side away from a deck, porch, balcony or stairs, without having to lean over a railing to reach the outer side of the balusters. The parts of the novel baluster hangar are rotated into a first position and the baluster hangar may then be passed between two adjacent balusters from their inner side closest to the deck, balcony or stairs so there is no danger of falling. The hangar is then rotated to its final position. Parts of the baluster hangar are stressed and deformed by pulling on the hook of the hangar and one piece is moved to a position that prevents the stress from being released to thereby lock the baluster hangar tightly against the sides of the balusters. The novel baluster hangar may also be attached to the inner of balusters, on their side nearest a deck, balcony or stairs.

### DESCRIPTION OF THE DRAWING

The invention will be better understood upon reading the following detailed description in conjunction with the drawing in which:

FIG. 1 shows the baluster hangar attached to two adjacent balusters;

FIG. 2 shows a side view of the baluster hangar attached to two adjacent balusters; and

FIG. 3 shows the baluster hangar as it is being attached to two adjacent balusters.

### DETAILED DEACRIPTION

What is disclosed is a baluster hanger that mounts quickly and easily to wooden, plastic or wrought iron balusters on a deck, porch, balcony or stairs, whether they are indoors or outdoors, without the need for tools. When installed the baluster hanger can be used to hang a wide variety of items such as planters, bird feeders, decorations and flags. The baluster hanger needs only two vertical balusters to be mounted to.

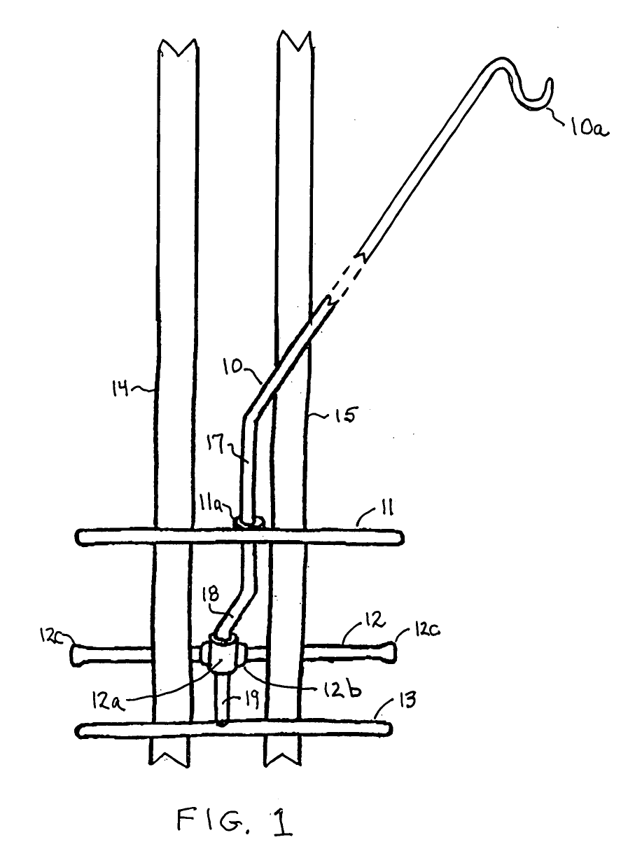

In FIG. 1 is shown a view of the baluster hangar attached to two adjacent, vertical balusters 14 and 15. The baluster hanger is fabricated primarily from one-eighth inch or larger steel rod, dependent on the maximum weight of items to be hung from the hangar. The hanger has a cross piece 13 of the same steel rod welded perpendicular to the lower end the hanger as shown. The length of piece 13 is sufficient to bridge across balusters 14 and 15.

There are two cylindrical steel pieces 11a and 12a that have an inside diameter slightly greater than one-eighth inch, the diameter of the rod from which the hangar is constructed, so they can freely rotate about and initially slide along the steel rod portions of the hanger that comprises portions 10, 16, 17, 18 and 19. After rod portions 10, 16, 17, 18 and 19 are bent as shown in FIGS. 1 through 3, piece 12a is constrained to rod portion 16, and piece 11a is constrained to rod portions 10 and 17.

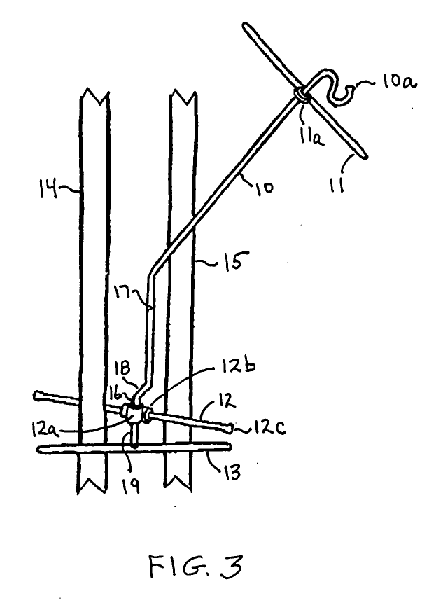

Welded to cylindrical piece 11a is another piece of steel rod 11 that is identical to cross rod 13. When so welded rod 11 is perpendicular to portion 17 of the hangar, and can slide along portion 17 and arm portion 10 as may be seen in FIG. 3.

Welded to cylindrical piece 12a is another cylindrical piece 12b. The axis through the cylindrical portion of piece 12b is perpendicular to the axis of the cylindrical portion of piece 12a. Passing through the cylindrical opening of piece 12b is another rod 12 that is the same as rods 11 and 13 except that its ends 12c are formed, after being inserted through piece 12b, so that they are bulbous and cannot pass back through the cylindrical hole through piece 12b.

The outer ends of the cross pieces 11, 12 and 13 may be coated with a rubber film (not shown) that may contain a small amount of sand embedded therein. The rubber and the sand, if used, provide additional friction to aid in holding the baluster hanger against the sides of balusters 14 and 15.

When the baluster hangar is installed against the sides of balusters 14 and 15, as shown in FIG. 1, there is stress placed on the various pieces that creates a spring force that holds rods 11, 12 and 13 tightly against balusters 14 and 15. The creation of these stresses is described further in this detailed description.

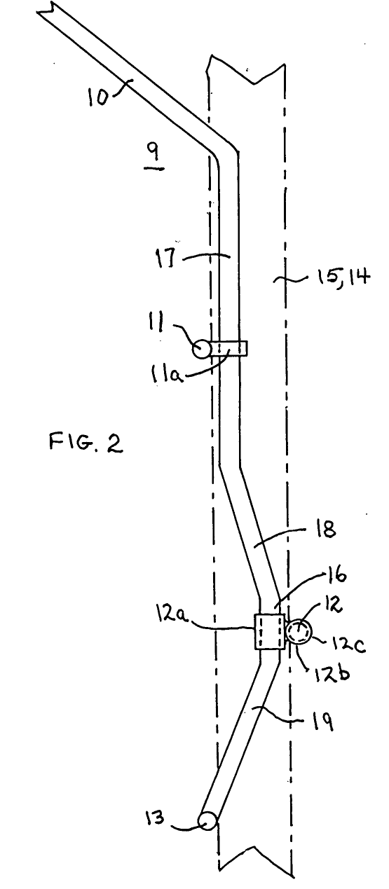

In FIG. 2 is shown a side view of the baluster hangar attached to the two adjacent balusters 14 and 15. Being a side view the individual balusters are not seen, and the details of the cross rods 11, 12 and 13 are not seen. The side view best shows the bends in the hangar that create the straight portions 10, 16, 17, 18 and 19. As previously described, the two bends that create portion 16 constrain cross rod 12 to that portion.

Starting at the bottom of the baluster hangar, cross rod 13 rests across the left side of balusters 14 and 15 as seen better in the other Figures. This side is called the front side of the balusters because it is where something hanging from the baluster holder is seen. The right side of balusters 14 and 15 is therefore called the rear side. As previously mentioned, when the hangar is fully mounted on balusters 14 and 15, as shown in FIGS. 1 and 2, there are stresses in the various pieces that tightly hold the baluster hangar against balusters 14 and 15.

In FIG. 3 is shown the baluster hangar as it is being attached to the two adjacent balusters 14 and 15. First, rotatable cross rod 11 is slid out near hook 10a as shown. Starting from the rear of the balusters the baluster hangar is rotated ninety degrees so that cross rod 13 can pass between baluster 14 and 15. Rod 12 is rotated and is slid through its piece 12b so that it can pass between the balusters 14 and 15. Similarly, cross rod 11 is rotated so that it can pass between balusters 14 and 15. Then the baluster hangar is rotated back to it upright position, as shown in FIG. 3, and fixed cross bar 13 is placed against balusters 14 and 15 as shown.

Then cross bar 12 is rotated and slid through its piece 12 so it can be passed back between balusters 14 and 15. It is then rotated so that it rest across the rear side of balusters 14 and 15 as shown in FIGS. 1 and 2. This is easily done because cross rod 11 is still out along rod portion 10 near hook 10a.

Cross rod is then slid back down along rod portion 10 to rest across balusters 14 and 15. Finally, to lock the baluster hangar in place, the outer end of portion is pushed or pulled downward. This force causes the baluster hangar to pivot about cross rod 12 while the lower end is held fast by cross rod 13, and the baluster hangar bends under the stress. Cross rod 11 is then slid further down from rod portion 10 onto rod portion 17, as shown in FIGS. 1 and 2. The more downward force there is on hook 10a of the baluster hangar the further cross bar 11 will slide downward along rod portion 17.

When the downward force on hook 10a is released cross rod 11 prevents the baluster hangar from returning to its unstressed original position. Thus, there is still stress in the hangar that causes cross rods 11, 12 and 13 to be held tightly against balusters 14 and 15 and the baluster hangar will not slide down along the balusters even when a load is hanging from hook 10a.

Depending on the material from which the balusters are made their thickness varies, and even from manufacturer to manufacturer. The novel baluster hangar is able to compensate for these differences. For the thickest balusters 14 and 15 cross rod 11 remains further up along rod portion 17 when the downward force on hook 10a is released. Visa versa, for the thinnest balusters 14 and 15 cross rod 11 remains further down along rod portion 17 when the downward force on hook 10a is released. Depending on the thickness of the balusters 14 and 15, rotatable cross rods 11 and 12 may be rotated one-hundred eighty degrees with respect to the elongated portion of the hangar and their position with respect to balusters 14 and 15 is shifted accordingly. This extends the adjustment range for different thickness.

While what has been described herein is the preferred embodiment of the invention those skilled in the art will recognize that numerous changes may be made without departing from the spirit and scope of the invention. For example, the hangar may also be mounted on any two vertical spaced members such as found in many fences.

1. A hangar attachable to the sides of two spaced vertical members for hanging items to the sides of the members, the hangar comprising:
an elongated portion having a hook at one end for hanging items;
a first cross rod attached permanently to the elongated portion furthest from the hook;
a second cross rod that is attached to the elongated portion in a manner that it may be rotated about the elongated portion, but is constrained from moving along the elongated portion; and
a third cross rod nearest the hook that is attached to the elongated portion in a manner that it may be rotated about the elongated portion, and it may also be moved along the elongated portion;
wherein when the hangar is mounted against the two spaced vertical members the first and third cross rods presses against a first side of the two spaced members and the second cross rod presses against a second side of the two spaced members that is opposite the first side to thereby prevent the hangar from sliding along the two spaced members.

2. The hangar in accordance with claim 1 wherein to attach the hangar to the sides of the balusters the hangar is rotated so that the first cross bar can be passed between two adjacent balusters, and the rotatable second and third cross bars are positioned so that they may also pass between the two adjacent balusters, the hangar is then rotated so that the fixed first cross bar rests across one side of the two adjacent balusters while the third cross bar is moved nearest to the hook, the rotatable second cross bar is then rotated to pass it back between the two adjacent crossbars and rest against the opposite side of the two balusters, a downward force is then placed on the hook to stress and deform the elongated member while the third cross bar is moved as far as possible from the hook and rest across the one side of the two balusters, and when the downward force on the hook is released the stress is not released and the first, second and third cross bars are held tightly against the two balusters.
